(19) United States
(12) Patent Application Publication
(10) Pub. No.: US 2006/0256506 A1
(43) Pub. Date: Nov. 16, 2006

(54) Solid electrolyte capacitor and process for producing same

(75) Inventors: Hiroshi Konuma, Tokyo (JP); Masahiro Kuroyanagi, Tokyo (JP); Masaaki Nishioka, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K.

(21) Appl. No.: 11/411,056

(22) Filed: Apr. 26, 2006

Related U.S. Application Data
(60) Provisional application No. 60/677,367, filed on May 4, 2005.
(60) Provisional application No. 60/755,796, filed on Jan. 4, 2006.

(30) Foreign Application Priority Data
Apr. 27, 2005 (JP) 2005-130108
Dec. 28, 2005 (JP) 2005-377660

(51) Int. Cl. H01G 9/00; H01G 4/228

(52) U.S. Cl. 361/540

(57) ABSTRACT

A solid electrolyte capacitor comprising a stack of solid electrolyte capacitor elements, anode lead and cathode lead, electrically connected to anode and cathode portions of the stack, respectively, wherein the stack, and the anode and cathode leads are encapsulated with a resin; and a part of the cathode lead and/or a part of the anode lead are exposed on the lower surface of capacitor to constitute cathode and anode terminals. A solid electrolyte capacitor comprising one or more solid electrolyte capacitor elements, anode lead and cathode lead, electrically connected to anode and cathode portions of the capacitor elements, respectively, wherein the capacitor elements, the anode lead and the cathode lead are encapsulated with a resin; a part of the cathode lead and/or a part of the anode lead are exposed on the lower surface of capacitor to constitute cathode and anode terminals; and other parts of the cathode and anode leads are disposed so as to extend upward and be exposed on the exterior sides of capacitor.

### CROSS-REFERENCE TO RELATED APPLICATION

This application is an application filed under 35 U.S.C. §111(a) claiming benefit pursuant to 35 U.S.C. §119(e) (1) of the filing dates of Provisional Application No. 60/677,367 filed May 4, 2005 and Provisional Application No. 60/755,796 filed Jan. 4, 2006, pursuant to 35 U.S.C §111(b).

### TECHNICAL FIELD

This invention relates to a solid electrolyte capacitor and a process for producing the capacitor. More specifically it relates to a solid electrolyte capacitor, parts of which have a reduced height, and a process for producing the solid electrolyte capacitor.

### BACKGROUND ART

Recently, electronic instruments have been progressed in their minimization in size and enhancement of frequency applied. As capacitors equipped in the electronic instruments, a solid electrolyte capacitor using an electrically conductive polymer as solid electrolyte is now commercially available which is capable of realizing a low impedance at a high frequency.

A solid electrolyte capacitor uses as solid electrolyte an electrically conductive polymer exhibiting a high electrical conductivity. Therefore, the solid electrolyte capacitor is characterized as exhibiting a reduced equivalent series resistance, and having a large capacitance and a small size, as compared with a conventional wet electrolyte capacitor using a liquid electrolyte or a conventional solid electrolyte capacitor using manganese dioxide. With an improvement of the properties, the commercially availability of the solid electrolyte capacitor is enhanced. Thus various electrically conductive polymers for use in the solid electrolyte have been developed, and solid electrolyte capacitors using the electrically conductive polymers have made a rapid progression.

These solid electrolyte capacitors include stacked or film or plate type capacitors, and wound type capacitors. Generally conventional stacked type capacitors comprise a stack of capacitor elements, each of which is made by a procedure wherein an electrode composed of a flat metal sheet having a valve action is subjected to anode-oxidation whereby a film is deposited on the surface of the metal electrode, a solid electrolyte layer comprising at least an electrically conductive polymer is formed on the film formed by anode-oxidation, and then a cathode electrically conductive layer is formed on the solid electrolyte layer.

Conventional stacked type solid electrolyte capacitors are produced by a process as illustrated in FIG. 1. In this process, as shown in FIG. 1(a), a plurality of capacitor elements 11a and 11b (two capacitor elements are herein shown as an example) are superposed to form a stack on a lead frame comprised of a cathode lead 21 and an anode lead 22. The stack of capacitor elements and the lead frame are encapsulated with a resin 12 except for outwardly extending end portions of the lead frame FIG. 1(b)]. An outwardly extending cathode lead 21 is downward folded to form a cathode terminal, and an outwardly extending anode lead 22 is downward folded to form an anode terminal [FIG. 1(c)] (Japanese Unexamined Patent Publication No. 2005-101496 and Japanese Unexamined Patent Publication No. 2005-311216).

The process wherein a cathode lead 21 and an anode lead 22 are encapsulated with a resin so that the leads are sandwiched between an upper part of the resin and a lower part of the resin as illustrated in FIG. 1 is conventionally adopted for packaging electronic parts. However, in the case where a cathode terminal and an anode terminal are fitted to the lower surface of a solid electrolyte capacitor for packaging a substrate with the capacitor, the cathode terminal 21 and the anode terminal 22 must be folded in a fashion such that the two terminals 21 and 22 hold the encapsulating resin 12 [FIG. 1(c)]. In view of a load imposed upon the folding the terminals, and processing precision for folding, the resin part to be held by the terminals have a certain thickness t′.

Thus, the minimum value of the height (t+t′) of conventional solid electrolyte capacitor parts is limited. Further, gaps “s” inevitably intervene between the side faces and the lower surface of the encapsulating resin 12, and the folded terminals 21 and 22. Therefore, the dimensions, especially heights, of the capacitor parts tend to be non-uniform.

### DISCLOSURE OF THE INVENTION

In view of the foregoing problems of the prior art, a primary object of the present invention is to provide a solid electrolyte capacitor, parts of which have a reduced height (t+t′), and to provide a process for producing the solid electrolyte capacitor.

The present inventors made extensive researches and found that solid electrolyte capacitor parts having a reduced height can be obtained by first means of providing a stacked type capacitor comprising a plurality of stacked solid electrolyte capacitor elements having a structure such that capacitor elements and a lead frame are encapsulated together with a resin in a fashion such that a part of a cathode lead and a part of an anode lead are exposed on the lower surface of a capacitor to constitute a cathode terminal and an anode terminal, which have no folded portions. They further found that solid electrolyte capacitor parts having a reduced height can be obtained by second means of providing a stacked type capacitor comprising a plurality of stacked solid electrolyte capacitor elements having a structure such that capacitor elements and a lead frame are encapsulated together with a resin in a fashion such that a part of a cathode lead and a part of an anode lead are exposed at least on the lower surface of the solid electrolyte capacitor so that the exposed parts constitute a cathode terminal and an anode terminal, respectively; and the cathode lead and the anode lead are cut off from the lead frame, and another part of the cathode lead and another part of the anode lead are folded so as to extend upward and be exposed on the exterior sides of the capacitor.

Thus, in accordance with the present invention, there are provided a solid electrolyte capacitor, a process for producing the capacitor, and an electronic or electrical equipment provided with the capacitor, which are recited in the following.

(1). A solid electrolyte capacitor comprising a stack of solid electrolyte capacitor elements, an anode lead and a cathode lead which are electrically connected to an anode portion of the stack and a cathode portion of the stack, respectively, wherein the stack, the anode lead and the cathode lead are encapsulated with a resin; and a part of the cathode lead and/or a part of the anode lead are exposed at least on the lower surface of the capacitor to constitute a cathode terminal and an anode terminal, respectively.

(2). The solid electrolyte capacitor as described above in (1), wherein the cathode lead and the anode lead have an approximately flat plate shape.

(3). A solid electrolyte capacitor comprising one or more solid electrolyte capacitor elements, an anode lead and a cathode lead which are electrically connected to an anode portion of the solid electrolyte capacitor elements and a cathode portion of the solid electrolyte capacitor elements, respectively, wherein the solid electrolyte capacitor elements, the anode lead and the cathode lead are encapsulated with a resin; a part of the cathode lead and/or a part of the anode lead are exposed at least on the lower surface of the solid electrolyte capacitor so that the exposed parts constitute a cathode terminal and an anode terminal, respectively; and another part of the cathode lead and another part of the anode lead are disposed so as to extend upward and be exposed on the exterior sides of the solid electrolyte capacitor.

(4). The solid electrolyte capacitor as described above in (3), which comprises two or more solid electrolyte capacitor elements which form a stack.

(5). The solid electrolyte capacitor as described above in (3), wherein said parts of the cathode lead and the anode lead which extend upward and are exposed on the exterior sides of the capacitor have a length corresponding to 20% to 80% of the height of the capacitor.

(6). The solid electrolyte capacitor as described above in (3), wherein each of the cathode lead and the anode lead is folded flat plate of an approximate L-shape.

(7). The solid electrolyte capacitor as described above in (1), wherein the solid electrolyte capacitor elements are superposed to form the stack so that anode portions of the capacitor elements coincide and cathode portions of the capacitor elements coincide.

(8). The solid electrolyte capacitor as described above in (1), wherein the lowermost surface of the cathode portions of the solid electrolyte capacitor elements is fixed and electrically connected to the upper surface of the cathode lead.

(9). The solid electrolyte capacitor as described above in (1), wherein the lowermost surface of the anode portions of the solid electrolyte capacitor elements is fixed and electrically connected to the upper surface of the anode lead.

(10). The solid electrolyte capacitor as described above in (1), wherein the cathode lead and/or the anode lead have projecting portions each having a lower surface located at a higher level than the exposed lower surface of the cathode lead and/or the anode lead, said projecting portions being covered with the resin.

(11). The solid electrolyte capacitor as described above in (10), wherein the difference in height between the lower surface of each projecting portion and the exposed lower surface of the cathode lead and/or the anode lead corresponds to 30% to 70% of the thickness of the cathode lead and/or the anode lead.

(12). The solid electrolyte capacitor as described above in (1), wherein the exposed areas of the cathode lead and/or the anode lead have a configuration designed so as to conform to each contacting surface of electrodes on a substrate onto which the solid electrolyte capacitor is fixed

(13). The solid electrolyte capacitor as described above in (1), wherein each solid electrolyte capacitor element comprises a metal substrate, a dielectric film formed by chemical formation of the surface of the metal substrate, and a solid electrolyte stacked on the dielectric film.

(14). A process for producing a solid electrolyte capacitor described above in (1), which comprises the steps of:

superposing two or more solid electrolyte capacitor elements in turn on a lead frame to form a stack of the capacitor elements, or fixing a stack of two or more solid electrolyte capacitor elements onto a lead frame;

encapsulating the stack of the capacitor elements, a part of the lead frame constituting a cathode lead, and a part of the lead frame constituting an anode lead with a resin in a fashion such that at least a part of the cathode lead and at least part of the anode lead are exposed on the lower surface of the encapsulated product; and

cutting the cathode lead and the anode lead to separate the encapsulated product from the remaining part of the lead frame.

(15). A process for producing a solid electrolyte capacitor described above in (3), which comprises the steps of:

fixing one or more solid electrolyte capacitor elements onto a lead frame;

encapsulating the solid electrolyte capacitor element or elements, a part of the lead frame constituting a cathode lead, and a part of the lead frame constituting an anode lead with a resin in a fashion such that at least a part of the cathode lead and at least part of the anode lead are exposed on the lower surface of the encapsulated product;

cutting the cathode lead and the anode lead to separate the encapsulated product from the remaining part of the lead frame; and

folding another part of the cathode lead and another part of the anode lead so as to extend upward and be exposed on the exterior sides of the solid electrolyte capacitor.

(16). The process for producing a solid electrolyte capacitor as described above in (15), wherein, in the step of fixing the solid electrolyte capacitor elements, two or more solid electrolyte capacitor elements are fixed onto the lead frame by a procedure wherein the solid electrolyte capacitor elements are superposed in turn on the lead frame to form a stack of the capacitor elements, or by a procedure wherein the solid electrolyte capacitor elements are superposed upon another to form a stack of the capacitor elements and then the stack is fixed onto the lead frame.

(17). The process for producing a solid electrolyte capacitor as described above in (14), which further comprises the step of blast finishing said part of the cathode lead and said part of the anode lead, which parts are exposed on the lower surface of the encapsulated product.

(18). An electronic instrument provided with the solid electrolyte capacitor described above in (1).

### EFFECT OF THE INVENTION

The solid electrolyte capacitor according to the present invention has terminals which are constituted by the parts of lead frame which are exposed on the lower surface of the capacitor, and wherein the lead frame does not have parts which are folded downward for holding an encapsulating resin. Therefore, there is no need for considering the load imposed and processing precision upon folding the terminals. Further, an encapsulating resin part corresponding to “t′” shown in FIG. 1(c) can be omitted. That is, the thickness of the encapsulating resin can be reduced to “t”.

In the case where a part of the cathode lead and a part of the anode lead are disposed so as to extend upward and be exposed on the exterior sides of the capacitor, the capacitor is more advantageous in that said parts extending upward can be more easily bonded by soldering as the electrode terminals to a substrate.

### BRIEF EXPLANATION OF THE DRAWINGS

FIG. 1 is a diagram illustrating an example of the process for producing a conventional solid electrolyte capacitor.

FIG. 2 is a sectional view illustrating an example of a first type solid electrolyte capacitor according to the present invention.

FIG. 3 is a sectional view illustrating another example of the first type solid electrolyte capacitor according to the present invention.

FIG. 4 is a sectional view illustrating a further example of the first type solid electrolyte capacitor according to the present invention.

FIG. 5 is a sectional view illustrating an example of a second type solid electrolyte capacitor according to the present invention.

FIG. 6 is a sectional view illustrating another example of the second type solid electrolyte capacitor according to the present invention.

FIG. 7 is a plan view of a lead frame used for the production of the first type solid electrolyte capacitor according to the present invention.

FIG. 8 is a plan view of a lead frame used for the production of the second type solid electrolyte capacitor according to the present invention.

FIG. 9 is a sectional view illustrating a typical example of a structure of capacitor element used in the present invention.

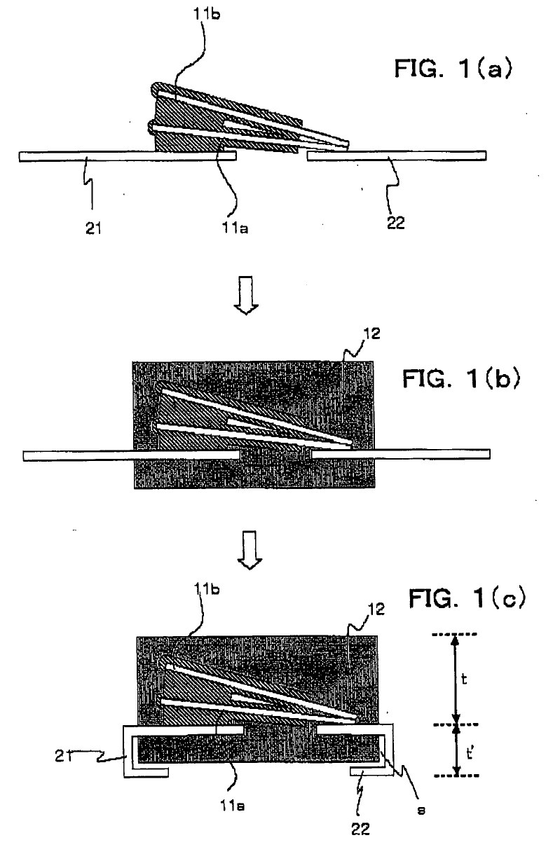

### Explanation of Reference Numerals

11, 11a, 11b: Solid electrolyte capacitor element

12, 33: Encapsulating resin

13: Metal sheet

14: Dielectric film

15: Solid electrolyte

16: Masking material

20: Solid electrolyte capacitor

21, 23, 25, 27: Part of cathode lead

22, 24, 26, 28: Part of anode lead

31: Lower surface of projecting portion of cathode lead

32: Lower surface of projecting portion of anode lead

34: Part of cathode lead exposed on exterior side of capacitor

35: Part of anode lead exposed on exterior side of capacitor

### BEST MODE FOR CARRYING OUT THE INVENTION

Solid Electrolyte Capacitor

The solid electrolyte capacitor according to the present invention includes the following two types of solid electrolyte capacitors.

(1) A solid electrolyte capacitor comprising a stack of solid electrolyte capacitor elements, an anode lead and a cathode lead which are electrically connected to an anode portion of the stack and a cathode portion of the stack, respectively, wherein the stack, the anode lead and the cathode lead are encapsulated with a resin; and a part of the cathode lead and/or a part of the anode lead are exposed at least on the lower surface of the capacitor to constitute a cathode terminal and an anode terminal, respectively (this type of solid electrolyte capacitor is hereinafter referred to as “first type solid electrolyte capacitor” when appropriate).

(2) A solid electrolyte capacitor comprising one or more solid electrolyte capacitor elements, an anode lead and a cathode lead which are electrically connected to an anode portion of the solid electrolyte capacitor elements and a cathode portion of the solid electrolyte capacitor elements, respectively, wherein the solid electrolyte capacitor elements, the anode lead and the cathode lead are encapsulated with a resin; a part of the cathode lead and/or a part of the anode lead are exposed at least on the lower surface of the solid electrolyte capacitor so that the exposed parts constitute a cathode terminal and an anode terminal, respectively; and another part of the cathode lead and another part of the anode lead are disposed so as to extend upward and be exposed on the exterior sides of the solid electrolyte capacitor (this type of solid electrolyte capacitor is hereinafter referred to as “second type solid electrolyte capacitor” when appropriate).

The solid electrolyte capacitor according to the present invention will now be described in detail with reference to the accompanying drawings.

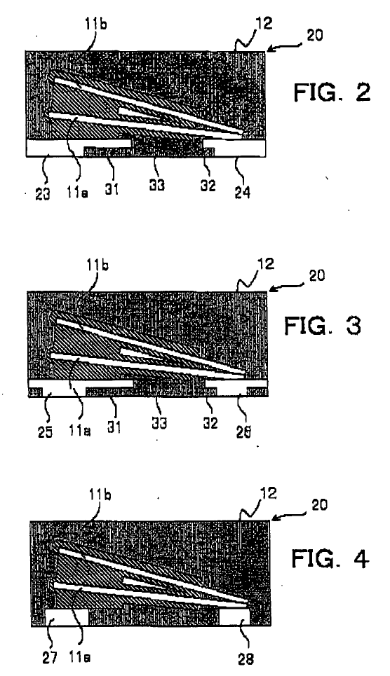

FIG. 2, FIG. 3 and FIG. 4 are sectional views illustrating examples of the first type solid electrolyte capacitor. As illustrated in these figures, the first type solid electrolyte capacitor 20 is a stacked type solid electrolyte capacitor comprising a stack of solid electrolyte capacitor elements 11a and 11b, disposed above the cathode lead part and/or the anode lead part, wherein the stack, the anode lead (23, 25, 27) and the cathode lead (24, 26, 28) are encapsulated with a resin in a fashion such that at least part of the cathode lead and/or at least part of the anode lead are exposed on at least the lower surface of the capacitor to constitute a cathode terminal and an anode terminal, respectively. Alternatively, one of the anode lead and the cathode lead may be exposed on the lower surface of the capacitor as illustrated in the above figures, and the other of the anode lead and the cathode lead may be exposed on side of the capacitor.

As illustrated in FIG. 4, the whole lower surface of the cathode lead part 27 and the whole lower surface of the cathode lead part 28 may be exposed on the lower surface of the capacitor so as to form a cathode terminal and an anode terminal, respectively. However, it is preferable that a part of the lower surface of the cathode lead part and a part of the lower surface of the cathode lead part are exposed on the lower surface of the capacitor. In one preferred embodiment, as illustrated in FIG. 2, an inward portion of the cathode lead part 23 and an inward portion of the anode lead part 24, which confront to each other, are made thin, and outer portion of the cathode lead part 23 and outer portion of the anode lead part 24 are exposed on the side and lower surface of the capacitor to constitute a cathode terminal an anode terminal.

In another preferred embodiment, as illustrated in FIG. 3, an inward portion of the cathode lead part 25 and an inward portion of the anode lead part 26, which confront to each other, are made thin, and an outer portion of the cathode part 25 and an outer portion of the anode part 27 are also made thin, and a central portion of the cathode part 25 and a central portion of the anode part are exposed on the lower surface of the capacitor to constitute a cathode terminal and an anode terminal, respectively.

In the embodiments illustrated in FIG. 2 and FIG. 3, a space 33 defined by the lower surface 31 of the inward projecting thin portion of the lead part 23 or 25 and the lower surface 32 of the inward projecting thin portion of the lead part 24 or 26 is filled with an encapsulating resin. In these embodiments, the contact areas of the cathode terminal and the anode terminal with the stacked solid capacitor elements are larger than the contact areas in the embodiment illustrated in FIG. 4. Thus, a problem of contact failure between capacitor elements and electrode terminals does not arise or is minimized in the embodiments of FIG. 2 and FIG. 3.

The above-mentioned positions of exposed lead parts and combinations thereof are examples and do not limit the capacitor according to the present invention. For example, as one variation, a part of the lower surface of one of the cathode lead part and the anode lead part is exposed on the lower surface of the capacitor, and the whole lower surface of the other of the cathode lead and the anode lead entire is exposed on the lower surface of the capacitor. As another variation, one of the cathode lead part and the anode lead part has a configuration as illustrated in FIG. 2, and the other of the cathode lead part and the anode lead part has a configuration as illustrated in FIG. 3.

The relative area of the exposed portion to the non-exposed portion encapsulated with a resin, and position of the exposed portion can be appropriately determined depending upon the thickness of lead part and arrangement of electrode terminals (for example, distance between adjacent electrode terminals, and their position, magnitude and shape).

In the case where a space 33 defined by the lower surface 31 of the inward projecting thin portion of lead part 23 or 25 and the lower surface 32 of the inward projecting thin portion of lead part 24 or 26 is filled with an encapsulating resin containing insoluble or infusible solid matter (filler particles) such as silica, the thickness of resin filled therein (that is, the difference in level between the lower surface 31 of the inward projecting thin portion and the lowermost surface of lead part 23 or 25; and the difference in level between the lower surface 32 of the inward projecting thin portion and the lowermost surface of lead part 24 or 26) is varied depending upon the size (particle diameters) of the insoluble or infusible solid matter (filler particles). Said thickness of resin is preferably at least two times of the size of insoluble or infusible solid matter. Further said thickness of resin is preferably 30% to 70% of the thickness of each lead part.

If an encapsulating resin containing no insoluble or infusible solid matter (filler particles) is used, the thickness of encapsulating resin can be thinner to any desired extent provided that the capacitor elements and the outside are electrically and physically partitioned from each other.

The stacked type solid electrolyte capacitor 20 is preferably designed so that a region of the cathode lead part 23 or 25 which is located right underneath the cathode part of the stacked capacitor elements is exposed on the lower surface of capacitor, and a region of the anode lead part 24 or 26 which is located right underneath the anode part of the stacked capacitor elements is also exposed on the lower surface of capacitor, as shown in FIG. 2 and FIG. 3.

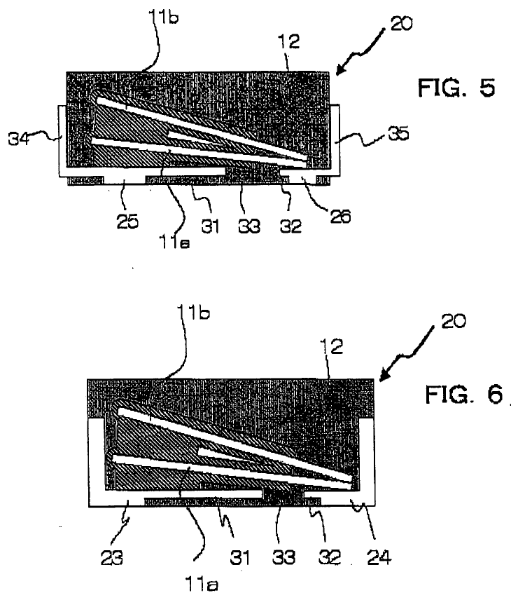

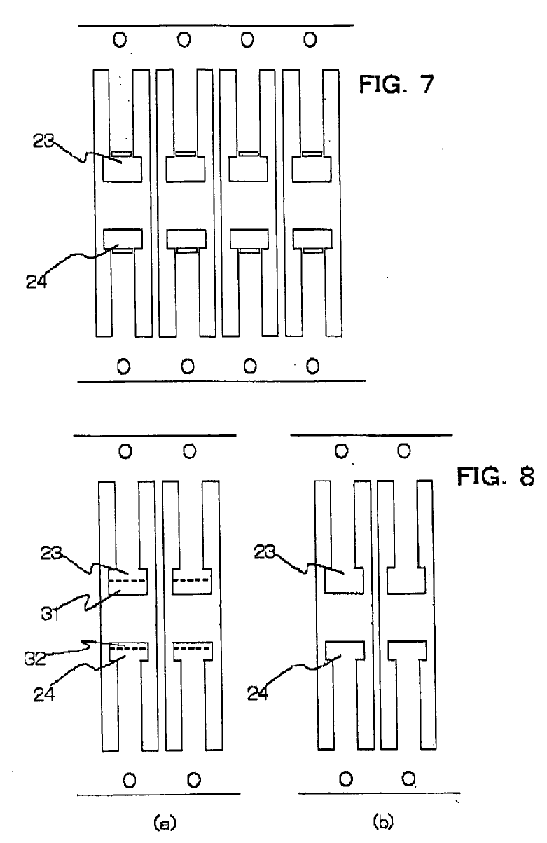

FIG. 5 and FIG. 6 are sectional views illustrating examples of the second type solid electrolyte capacitor.

As illustrated in these figures, the second type solid electrolyte capacitor 20 is a stacked type solid electrolyte capacitor comprising a stack of solid electrolyte capacitor elements 11a and 11b, a cathode lead part 25 or 23 and/or a anode lead part 26 or 24, which are encapsulated with a resin 12.

In the embodiments shown in FIG. 5 and FIG. 6, the stack of solid electrolyte capacitor elements is composed of two solid electrolyte capacitor elements. However, in other embodiments (not shown), a single solid electrolyte capacitor element may be used or a stack of three or more solid electrolyte elements may be used, instead of the stack of two capacitor elements.

In the stack of at least two solid electrolyte capacitor elements, the solid electrolyte capacitor elements are stacked together generally in a manner such that the respective cathode parts of the stacked capacitor elements are vertically superposed upon another, and the respective anode parts thereof are vertically superposed upon another. In this manner of superposition, the respective cathode parts of capacitor elements are electrically connected to each other and the respective anode parts of capacitor elements are electrically connected to each other. The procedure by which the respective electrode parts are electrically connected is not particularly limited, and includes, for example, an adhering method using an electrically conductive paste, a soldering method and a welding method. The number of capacitor elements to be stacked is not particularly limited, and varies depending upon the desired capacitance of capacitor and the desired height of capacitor part. But, the number of capacitor elements is, for example, in the range of 1 to 20, preferably 2 to 12.

The anode lead 24 or 26 is electrically connected to the anode part of the solid electrolyte capacitor elements. More specifically the anode lead 24 or 26 is electrically connected to each metal substrate having a valve action of the capacitor elements. In the embodiments shown in FIG. 5 and FIG. 6, the upper surface of anode lead 24 or 26 is contacted with the lowermost surface of the anode part of the solid electrolyte capacitor elements to achieve an electrical connection.

The cathode lead 23 or 25 is electrically connected to the cathode part of the solid electrolyte capacitor elements. More specifically the cathode lead 23 or 25 is electrically connected to the solid electrolyte of capacitor. In the embodiments shown in FIG. 5 and FIG. 6, the upper surface of cathode lead 23 or 25 is contacted with the lowermost surface of the cathode part of the solid electrolyte capacitor elements to achieve an electrical connection.

The anode lead and the cathode lead are not particularly limited in shape, but are preferably folded flat plates of an approximately L-shape, as shown in FIG. 5 and FIG. 6.

In the second type solid electrolyte capacitor according to the present invention, a part of the cathode lead and/or a part of the anode lead are exposed at least on the lower surface of the solid electrolyte capacitor so that the exposed parts constitute a cathode terminal and an anode terminal, respectively.

Further, another part of the cathode lead and another part of the anode lead are disposed so as to extend upward and be exposed on the exterior sides of the solid electrolyte capacitor.

In the embodiments shown in FIG. 5 and FIG. 6, each of the cathode lead and the anode lead is exposed on both of the lower surface and side of capacitor. However, in modified embodiments, one of the cathode lead and the anode lead may be exposed only on the lower surface of capacitor, and the other lead may be exposed only on the side of capacitor.

The arrangement and configuration of the exposed portion of the cathode lead and the exposed portion of the anode lead can be appropriately designed depending upon the arrangement and configuration of the region of a substrate to which the electrode terminals of capacitor are packaged.

The stacked type solid electrolyte capacitor 20 is preferably designed so that a region of the cathode lead part 23 or 25 which is located right underneath the cathode part of the stacked capacitor elements is exposed on the lower surface of capacitor, and a region of the anode lead part 24 or 26 which is located right underneath the anode part of the stacked capacitor elements is also exposed on the lower surface of capacitor, as shown in FIG. 5 and FIG. 6.

The cathode lead and/or the anode lead have inward projecting thin portions, the lower surfaces 31 and 32 of which are located at a level higher than that of the exposed lowermost surfaces of the cathode lead and/or the anode lead. The difference in level of height between the lower surfaces 31 and 32 of the inward projecting thin portions and the lowermost surfaces of cathode lead part 23 or 25 and/or anode lead part 24 or 26 is preferably 30% to 70% of the thickness of each lead part. By the provision of the inward projecting thin portions, lead terminals can be more firmly fitted.

In the solid electrolyte capacitor shown in FIG. 6, the cathode lead 23 has an inward extending thin portion and the anode lead 24 has an inward extending thin portion. Each of the cathode lead 23 and the anode lead 24 is folded in an L shape, and a part of the folded lead upward extends to form a part of the side of capacitor.

In the solid electrolyte capacitor shown in FIG. 5, the cathode lead 25 has an inward extending portion and outward extending portion (thin portion), and the anode lead 26 has an inward extending portion and an outward extending portion. Each of the two outward extending portions in FIG. 5 is folded in an L shape and a part 34 or 35 of the folded portion upward extends along the exterior of capacitor 20.

The length (height) of the upward extending part or portion of each lead is not particularly limited, but the upward extending part or portion preferably has a height corresponding to 20 to 80%, more preferably 30 to 70% of the height of capacitor.

The above-mentioned positions of exposed lead parts and combinations thereof are examples and do not limit the capacitor according to the present invention. For example, as one variation, one of the cathode lead part and the anode lead part is wholly exposed and the other thereof is partly exposed. As another variation, one of the cathode lead part and the anode lead part has a configuration as shown in FIG. 5 and the other thereof has a configuration as shown in FIG. 6.

The relative area of the exposed portion to the non-exposed portion encapsulated with a resin, and position of the exposed portion can be appropriately determined depending upon the thickness of lead part and arrangement of electrode terminals (for example, distance between adjacent electrode terminals, and their position, magnitude and shape).

In the case where a space 33 defined by the lower surface 31 of the inward projecting thin portion of lead part 23 or 25 and the lower surface 32 of the inward projecting thin portion of lead part 24 or 26 is filled with an encapsulating resin containing insoluble or infusible solid matter (filler particles) such as silica, the thickness of resin filled therein is varied depending upon the size (particle diameters) of the solid matter (filler particles). Said thickness of resin is preferably at least two times of the size of solid matter. If an encapsulating resin containing no insoluble or infusible solid matter is used, the thickness of encapsulating resin can be thinner to any desired extent provided that the capacitor elements and the outside are electrically and physically partitioned from each other.

In the first type solid electrotype capacitor and the second type solid capacitor according to the present invention, solid electrolyte capacitor elements 11a and 11b used can be conventional. The shape of the capacitor elements is not particularly limited, but preferably be of a shape suitable for stacking the capacitor elements, which includes, for example, a foil or sheet or thin plate, a rod and a wire. Substantially flat-shaped elements such as foil-shaped and sheet-shaped elements are especially preferable.

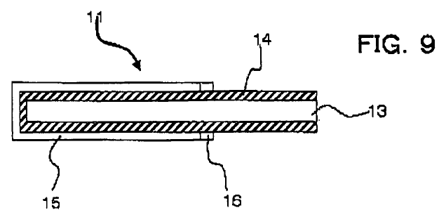

FIG. 9 is a sectional view illustrating a typical example of a structure of the capacitor element used in the present invention. The solid electrolyte capacitor element shown in FIG. 9 comprises a metal substrate 13, a dielectric film 14 formed by chemical conversion of the surface of metal substrate 13, and a solid electrolyte layer 15 stacked on the dielectric film 14. The metal substrate 13 constitutes an anode and the solid electrolyte layer 15 constitutes a cathode. If desired, an electrically conductive layer (not shown) may be formed on the solid electrolyte layer 15 to reduce the contact resistance with a cathode lead.

The metal substrate 13 is generally made of a metal having a valve action. Such metal includes single metals such as aluminum, tantalum, niobium, titanium, zirconium, magnesium and silicon, and alloys thereof. The metal substrate maybe composed of porous bodies of these metals. The porous body may have any configuration provided that it is porous, which includes, for example, an etched product of calendared metal foil and a sintered body of fine metal powder. The thickness of metal substrate 13 varies depending upon the particular use thereof, and, it is for example in the range of about 40 to 300 μm. To make a thin solid electrolyte capacitor from a metal foil such as aluminum foil, the metal foil used preferably has a thickness in the range of 80 to 250 μm.

The size and shape of metal foil are not particularly limited, but, a rectangular-form element unit having a length of about 1 to 50 mm and a width of about 1 to 50 mm is preferably used. A rectangular-form element unit having a length of about 2 to 25 mm and a width of about 2 to 15 mm is especially preferable.

The dielectric film 14 can be formed by chemically converting the above-mentioned metal substrate. The chemical conversion includes, for example, an anode oxidation treatment and a chemical treatment using, for example, an alkali.

The solid electrolyte used for the solid electrolyte element is not particularly limited, but is preferably a polymer produced by electrolytic polymerization or oxidative polymerization.

The electrically conductive layer is formed by, for example, applying an electrically conductive paste, plating or deposition, or adhering an electrically conductive resin film. A masking can be provided to enhance the insulation between the cathode composed of solid electrolyte 15 and the anode composed of metal substrate 13.

The resin (encapsulating resin) used for encapsulating the above-mentioned solid electrolyte capacitor elements, the anode lead and the cathode lead for the manufacture of the solid electrolyte capacitor according to the present invention can be selected from resins conventionally used in this field. As a preferable resin, there can be mentioned an epoxy resin, a fluororesin, a silicone resin and a urethane resin. Solid materials (filler particles) such as silica can be incorporated in the resin.

Process for Producing Solid Electrolyte Capacitor

The first type solid electrolyte capacitor according to the present invention is produced by a process comprising the steps of superposing two or more solid electrolyte capacitor elements in turn on a lead frame (which have cathode lead parts and anode lead parts which may have a thin portion on the lower side thereof) to form a stack of the capacitor elements, or fixing a stack of two or more solid electrolyte capacitor elements onto a lead frame; and then encapsulating the stack of the capacitor elements, a part of the lead frame constituting a cathode lead, and a part of the lead frame constituting an anode lead with an encapsulating resin in a fashion such that at least a part of the lower surface of cathode lead and at least part of the lower surface of anode lead are exposed on the lower surface of the encapsulated product.

Usually, on a lead frame wherein a plurality of cathode lead parts 23 and a plurality of anode lead parts 24 are fitted so as to confront to each other with an intervening space as illustrated in FIG. 7, solid electrolyte capacitor elements are superposed in turn to form a stack of the capacitor elements, or a previously prepared stack of the capacitor elements is fixed, in a fashion such that the cathode part of stacked capacitor elements and the anode part of stacked capacitor elements are positioned on the cathode lead parts and the anode lead parts, respectively. The procedure for superposing in turn the solid electrolyte capacitor elements, and the procedure for fixing the stack of solid electrolyte capacitor elements can be selected from conventional procedures as mentioned above.

Then the solid electrolyte capacitor elements, the cathode lead parts and the anode lead parts are encapsulated with an encapsulating resin in a fashion such that at least a part of the lower surface of cathode lead parts and at least part of the lower surface of anode lead parts are exposed on the lower surface of the encapsulated product. The resin is cured, and then thus-fitted units of resin-encapsulated solid electrolyte capacitor elements are cut at the respective side ends and separated from the lead frame. The encapsulation with the resin can be carried out by an appropriate conventional procedure adopted in this field, which procedure includes, for example, casting, compression molding and injection molding. Among the casting procedures, a transfer molding using a multi-plunger with a plurality of pots is preferable.

The second type solid electrolyte capacitor according to the present invention is produced by a process comprising the steps of fixing one or more solid electrolyte capacitor elements onto a lead frame; encapsulating the solid electrolyte capacitor element or elements, a part of the lead frame constituting a cathode lead, and a part of the lead frame constituting an anode lead with a resin in a fashion such that at least a part of the cathode lead and at least part of the anode lead are exposed on the lower surface of the encapsulated product; cutting the cathode lead and the anode lead to separate the encapsulated product from the remaining part of the lead frame; and folding another part of the cathode lead and another part of the anode lead so as to extend upward and be exposed on the exterior sides of the solid electrolyte capacitor.

FIG. 8(a) and FIG. 8(b) are plan views of one example of a lead frame used for the production of the second type solid electrolyte capacitor according to the present invention. The lead frame is fabricated by punching a flat sheet so that anode lead parts 23 and cathode lead parts 24 are formed. As illustrated in FIG. 8(a), each anode lead part 23 has an inward extending thin portion 31 with step between the thin portion 31 and the remaining part. Each cathode lead part 24 has an inward extending thin portion 24 with step between the thin portion 32 and the remaining portion.

In the production process, a solid electrolyte capacitor element or elements are fixed onto the lead frame. The procedure for fixing the capacitor elements on the lead frame is not particularly limited. For example, adhering using an electrically conductive paste, soldering and welding can be adopted.

In the case when two or more solid electrolyte capacitor elements are fixed on the lead frame, (1) a procedure wherein one solid electrolyte capacitor element is fixed on the lead frame, and other element or elements are superposed upon another in turn on the lead frame; and (2) a procedure wherein a previously prepared stack of solid electrolyte capacitor elements is fixed on the lead frame, can be adopted.

Then the solid electrolyte capacitor element or elements, a part of the lead frame constituting a cathode lead, and a part of the lead frame constituting an anode lead with a resin in a fashion such that a part of the cathode lead and a part of the anode lead are exposed on the lower surface of the encapsulated product. The encapsulation with a resin can be carried out by an appropriate conventional procedure adopted in this field, which procedure includes, for example, casting, compression molding and injection molding. Among the casting procedures, a transfer molding using a multi-plunger with a plurality of pots is preferable. After the encapsulation with a resin, the lower exposed part of cathode lead and the lower exposed part of anode lead are preferably subjected to a blasting treatment. Thereby a resin undesirably remaining on the lower exposed parts of cathode lead and anode lead can be completely removed to assure good electrical conduction.

After the encapsulation with a resin, the cathode lead and the anode lead are cut off from the lead frame in a fashion that the cathode lead has an outward extending portion and the anode lead has an outward extending portion, which portions are exposed and protrude in the exterior sides of the encapsulated body.

The outward protruding portions are folded so that the tip portions thereof are extend upward and be exposed on the exterior sides of the solid electrolyte capacitor. Thus the solid electrolyte capacitor according to the present invention can be obtained.

### EXAMPLE 1

### Production of First Type Solid Electrolyte Capacitor

A rectangular chemical conversion aluminum foil having a size of 11 mm length×3.3 mm width (available from Japan Capacitor Industrial Co., Ltd., 110LJB22-4vf; hereinafter abbreviated to as “chemical conversion foil”) was prepared. A masking made of a heat-resistant resin having a strip form with a 1 mm width is formed so that the strip surrounds the chemical conversion foil at a position of 4 mm apart from a short side of the chemical conversion foil. Thus the chemical conversion foil was partitioned by the masking strip into an anode part having a size of 3.3 mm width×4 mm length and a cathode part having a size of 3.3 mm width×6 mm length.

The cathode part of chemical conversion foil was immersed in an aqueous ammonium adipate solution with a 10% by mass concentration as an electrolyte solution where chemical conversion was conducted at a temperature of 55° C., a voltage of 4 V, a current density of 5 mA/cm², and a current application time of 10 minutes. The thus-treated cathode part was washed with water. The cathode part had a fine porous surface.

The chemically converted cathode part was immersed in a 1 mol/l solution of 3,4-ethylenedioxythiophene in isopropyl alcohol for 2 minutes. Then, the cathode part was immersed in an aqueous mixed solution of an oxidizing agent (aqueous 1.5 mol/l ammonium persulfate solution) and a dopant (aqueous 0.15 mol/l sodiumnaphthalene-2-sulfonate solution) at a temperature of 45° C. for 5 minutes to conduct oxidative polymerization for forming a solid electrolyte film.

The procedures of the immersion treatment with 3,4-ethylenedioxythiophene, the immersion treatment with the oxidizing agent/dopant mixd solution, and the oxidative polymerization were repeated 12 times in total whereby a solid electrolyte film was formed within fine micro-pores and on the surface of the cathode part.

The thus-obtained chemical conversion foil was washed with warm water at a temperature of 50° C., and then, the cathode part was again immersed in an aqueous ammonium adipate solution with a 10% by mass concentration as an electrolyte solution where chemical conversion was conducted at a temperature of 55° C., a voltage of 4 V, a current density of 5 mA/cm², and a current application time of 10 minutes. The thus-treated cathode part was washed with water, and then dried at a temperature of 100° C. for 30 minutes.

A carbon paste and a silver paste were coated in turn on the solid electrolyte film to form a cathode electrically conductive layer.

The anode part of the thus-obtained chemical conversion foil was cut so that 1 mm width portion of the anode part, adjacent to the masking strip, remained but the other portion thereof was separated whereby solid electrolyte capacitor elements each having a structure as illustrated in FIG. 9 were obtained. Two solid electrolyte elements were stacked together by using an electrically conductive adhesive composed of a silver paste so that the cathode parts of capacitor elements are electrically connected. The stack of capacitor elements was fitted on a lead frame with a thickness of 0.15 mm having a shape as illustrated in FIG. 7, which was made of CDA19400 (a Cu—Fe—Zn—P alloy). More specifically, the cathode parts of the stacked capacitor elements are adhered on a cathode lead part of the lead frame by using an electrically conductive adhesive composed of a silver paste, and the anode parts of the stacked capacitor elements are bonded to an anode lead part of the lead frame by resistance welding. As illustrated in FIG. 2 or FIG. 3, the cathode lead part 23 or 25 of the lead frame and the anode lead part 24 or 26 of the lead frame had inward-extending thin portions 31 and 32, respectively, on the capacitor elements-fitted side. The difference in thickness between the inward-extending thin portions 31 and 32 and the other portions of cathode lead part 23 or 25 and anode lead part 24 or 26 was 0.075 mm on average.

The thus-obtained stack of solid capacitor elements, the cathode lead part of lead frame and the anode lead part of lead frame were encapsulated with an encapsulating resin (discrete epoxy resin) to give an encapsulated part having a height of 1 mm. The encapsulated part was aged at a temperature of 135° C. and a voltage of 2.5 V for 45 minutes. The anode lead part and the cathode lead part were cut to separate the encapsulated part comprising the two stacked capacitor elements from the lead frame. Thus 100 solid electrolyte capacitors having a rated capacitance of 100 μF and a rated voltage of 2 V were obtained.

The solid electrolyte capacitors have an average height of 0.97 mm, which was about 50% lower than the conventional solid electrolyte capacitors (average height: 1.9 mm). Standard deviation of the height was about 0.02 mm, and thus the capacitors were more uniform and had a higher precision than the conventional solid electrolyte capacitors.

### EXAMPLE 2

### Production of Second Type Solid Electrolyte Capacitor

Solid electrolyte capacitor elements were prepared by the same procedures as mentioned in Example 1. Two solid electrolyte capacitor elements were fitted onto a lead frame having a shape as illustrated in FIG. 8 which had a cathode lead part 23 having an inward-extending thin portion 31 and an anode lead part 24 having an inward-extending thin portion 32 on the capacitor elements-fitted side. The difference in thickness between the inward-extending thin portions 31 and 32 and the other portions of cathode lead part 23 or anode lead part 24 was 0.075 mm on average.

The thus-obtained stack of solid capacitor elements, the cathode lead part of lead frame and the anode lead part of lead frame were encapsulated with an encapsulating resin (discrete epoxy resin) to give an encapsulated part having a height of 1 mm. The encapsulated part was aged at a temperature of 135° C. and a voltage of 2.5 V for 45 minutes. Then the lower exposed cathode lead part and the lower exposed anode lead part were subjected to a blasting treatment using a sand-blasting machine (SFK-2 available from Fuji Manufacturing Co.). The anode lead part and the cathode lead part were cut at positions 0.7 mm apart from the side end of resin-encapsulated part, respectively, to separate the encapsulated part comprising the two stacked capacitor elements from the lead frame. Each of the anode lead part and the cathode lead part had a protruding lead portion having a length of 0.7 mm. The protruding portions were folded upward on the exterior surface of the encapsulated part as illustrated as reference numerals 34 and 35 in FIG. 5. Thus 100 solid electrolyte capacitors having a rated capacitance of 100 μF and a rated voltage of 2 V were obtained.

The solid electrolyte capacitors have an average height of 0.97 mm, which was about 50% lower than the conventional solid electrolyte capacitors (average height: 1.9 mm). Standard deviation of the height was about 0.02 mm, and thus the solid electrolyte capacitors were more uniform and had a higher precision than the conventional solid electrolyte capacitors.

### INDUSTRIAL APPLICABILITY

The solid electrolyte capacitor according to the present invention can be reduced in size and height, and thus, arrangement and size of electrodes can be deigned with an enhanced freedom. Therefore, the solid electrolyte capacitor is widely used for various electrical and electronic instruments and appliances such as, for example, household appliances, automobile parts, industrial hardware and machines, and portable instruments and appliances.

1. A solid electrolyte capacitor comprising a stack of solid electrolyte capacitor elements, an anode lead and a cathode lead which are electrically connected to an anode portion of the stack and a cathode portion of the stack, respectively, wherein the stack, the anode lead and the cathode lead are encapsulated with a resin; and at least part of the cathode lead and/or at least part of the anode lead are exposed at least on the lower surface of the capacitor to constitute a cathode terminal and an anode terminal, respectively.

2. The solid electrolyte capacitor according to claim 1, wherein the cathode lead and the anode lead have an approximately flat plate shape.

3. A solid electrolyte capacitor comprising one or more solid electrolyte capacitor elements, an anode lead and a cathode lead which are electrically connected to an anode portion of the solid electrolyte capacitor elements and a cathode portion of the solid electrolyte capacitor elements, respectively, wherein the solid electrolyte capacitor elements, the anode lead and the cathode lead are encapsulated with a resin; a part of the cathode lead and/or a part of the anode lead are exposed at least on the lower surface of the solid electrolyte capacitor so that the exposed parts constitute a cathode terminal and an anode terminal, respectively; and another part of the cathode lead and another part of the anode lead are disposed so as to extend upward and be exposed on the exterior sides of the solid electrolyte capacitor.

4. The solid electrolyte capacitor according to claim 3, which comprises two or more solid electrolyte capacitor elements which form a stack.

5. The solid electrolyte capacitor according to claim 3, wherein said parts of the cathode lead and the anode lead which extend upward and are exposed on the exterior sides of the capacitor have a length corresponding to 20% to 80% of the height of the capacitor.

6. The solid electrolyte capacitor according to claim 3, wherein each of the cathode lead and the anode lead is a folded flat plate of an approximate L-shape.

7. The solid electrolyte capacitor according to claim 1, wherein the solid electrolyte capacitor elements are superposed to form the stack so that anode portions of the capacitor elements coincide and cathode portions of the capacitor elements coincide.

8. The solid electrolyte capacitor according to claim 1, wherein the lowermost surface of the cathode portions of the solid electrolyte capacitor elements is fixed and electrically connected to the upper surface of the cathode lead.

9. The solid electrolyte capacitor according to claim 1, wherein the lowermost surface of the anode portions of the solid electrolyte capacitor elements is fixed and electrically connected to the upper surface of the anode lead.

10. The solid electrolyte capacitor according to claim 1, wherein the cathode lead and/or the anode lead have projecting portions each having a lower surface located at a higher level than the exposed lower surface of the cathode lead and/or the anode lead, said projecting portions being covered with the resin.

11. The solid electrolyte capacitor according to claim 10, wherein the difference in height between the lower surface of each projecting portion and the exposed lower surface of the cathode lead and/or the anode lead corresponds to 30% to 70% of the thickness of the cathode lead and/or the anode lead.

12. The solid electrolyte capacitor according to claim 1, wherein the exposed areas of the cathode lead and/or the anode lead have a configuration arranged to conform to a contacting surface of electrodes on a substrate onto which the solid electrolyte capacitor is to be fixed

13. The solid electrolyte capacitor according to claim 1, wherein said solid electrolyte capacitor elements each comprises a metal substrate, a dielectric film formed by chemical conversion of the surface of the metal substrate, and a solid electrolyte stacked on the dielectric film.

14. A process for producing the solid electrolyte capacitor of claim 1, which comprises the steps of:
superposing two or more solid electrolyte capacitor elements in turn on a lead frame to form a stack of the capacitor elements, or fixing a stack of two or more solid electrolyte capacitor elements onto a lead frame;
encapsulating the stack of the capacitor elements, a part of the lead frame constituting a cathode lead, and a part of the lead frame constituting an anode lead with a resin in a fashion such that at least a part of the cathode lead and at least part of the anode lead are exposed on the lower surface of the encapsulated product; and
cutting the cathode lead and the anode lead to separate the encapsulated product from the remaining part of the lead frame.

15. A process for producing the solid electrolyte capacitor of claim 3, which comprises the steps of:
fixing one or more solid electrolyte capacitor elements onto a lead frame;
encapsulating the solid electrolyte capacitor element or elements, a part of the lead frame constituting a cathode lead, and a part of the lead frame constituting an anode lead with a resin in a fashion such that at least a part of the cathode lead and at least part of the anode lead are exposed on the lower surface of the encapsulated product;
cutting the cathode lead and the anode lead to separate the encapsulated product from the remaining part of the lead frame; and
folding another part of the cathode lead and another part of the anode lead so as to extend upward and be exposed on the exterior sides of the solid electrolyte capacitor.

16. The process for producing a solid electrolyte capacitor according to claim 15, wherein, in the step of fixing the solid electrolyte capacitor elements, two or more solid electrolyte capacitor elements are fixed onto the lead frame by a procedure wherein the solid electrolyte capacitor elements are superposed in turn on the lead frame to form a stack of the capacitor elements, or by a procedure wherein the solid electrolyte capacitor elements are superposed upon another to form a stack of the capacitor elements and then the stack is fixed onto the lead frame.

17. The process for producing a solid electrolyte capacitor according to claim 14, which further comprises the step of blast finishing said part of the cathode lead and said part of the anode lead, which parts are exposed on the lower surface of the encapsulated product.

18. An electronic instrument provided with the solid electrolyte capacitor as claimed in claim 1.

19. The process for producing a solid electrolyte capacitor according to claim 15, which further comprises the step of blast finishing said part of the cathode lead and said part of the anode lead, which parts are exposed on the lower surface of the encapsulated product.

20. The process for producing a solid electrolyte capacitor according to claim 16, which further comprises the step of blast finishing said part of the cathode lead and said part of the anode lead, which parts are exposed on the lower surface of the encapsulated product.

21. An electronic instrument provided with the solid electrolyte capacitor as claimed in claim 2.

22. An electronic instrument provided with the solid electrolyte capacitor as claimed in claim 3.
